(19) United States
(12) Patent Application Publication
(10) Pub. No.: US 2007/0131493 A1
(43) Pub. Date: Jun. 14, 2007

(54) Disc brake for vehicles and brake lining for a disc brake

(75) Inventors: Tobias Linke, Bad Vilbel (DE); Markus Stoehr, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahrzeuge GmbH, Muenchen (DE)

(21) Appl. No.: 11/600,862

(22) Filed: Nov. 17, 2006

(30) Foreign Application Priority Data
Nov. 18, 2005 (DE) 10 2005 055 118.1

(51) Int. Cl. F16D 66/02

(52) U.S. Cl. 188/1.11 R

(57) ABSTRACT

A disc brake, in particular its brake lining, is provided with at least one temperature indicator which changes state after a permitted operating temperature is exceeded and/or remains in its position after a permitted operating temperature is exceeded. The temperature indicator may be, in particular, a coating of an adhesive or paint, an affixed label or an affixed tag.

### BACKGROUND AND SUMMARY OF THE INVENTION

This application claims the priority of German Application No. 10 2005 055 118.1, filed Nov. 18, 2005, the disclosure of which is expressly incorporated by reference herein.

The invention relates to a disc brake for vehicles having a brake caliper, an application device, a brake disc and brake linings arranged on both sides of the brake disc in brake lining slots of the brake caliper. The invention also relates to a brake lining for such a disc brake.

The previously described disc brake is designed, in particular, for commercial vehicles. In such commercial vehicles, in particular in the loaded state as a result of the relatively high permissible total weight, correspondingly high brake forces occur, which lead to an increase in the temperature of the disc brake. The brake linings, and the brake disc in particular, are thermally loaded as a result. Maximum temperatures are therefore prescribed for the thermal loading of a brake. If the prescribed temperature is exceeded, the maximum braking force can decrease, and damage can occur to the disc brake (“thermal overloading of the brake system”). Such overloading may be caused by improper actuation or by other damage to the braking system. It has hitherto been difficult, if at all possible, to account for the resulting after-effects to the braking system.

The invention is based on the object of designing a disc brake of the above-mentioned type such that, in the event of damage, it can be proven as accurately as possible that an instance of damage or a decrease in the maximum braking force can be attributed to the permitted operating temperature being exceeded or to a thermal overload of the disc brake.

This is achieved by providing a disc brake for vehicles having a brake caliper, an application device, a brake disc and brake linings arranged on both sides of the brake disc in brake lining slots of the brake caliper. The disc brake is provided with at least one temperature indicator, which changes state after a permitted operating temperature is exceeded and/or remains in its position after a permitted operating temperature is exceeded. According to the invention, the disc brake, or in particular at least one of its brake linings, is provided with at least one temperature indicator which changes state after a permitted operating temperature is exceeded and/or remains in its position after a permitted operating temperature is exceeded.

In order to verify that a thermal overload of the disc brake occurred, the temperature indicator(s) can be used in a very wide variety of embodiments. It must be ensured that, up to a defined operating temperature, no change in state occurs or, in the case of a corresponding design of the temperature indicator, for example a pointer or the like returns to its initial position. If the conditions are met, it can be assumed to be indisputable, for example in the event of a warranty claim, that no thermal overload of the disc brake has taken place.

In the simplest embodiment, it is provided that at least one temperature indicator is arranged on at least one lining support of at least one brake lining. Since the brake linings are subjected to a particular thermal loading, it is extremely advantageous to attach the temperature indicator to the lining support.

To enhance the proof of a thermal overload of the disc brake, it can, however, also be advantageous for in each case one temperature indicator to be arranged on a plurality of brake linings of the disc brake. In addition, it is possible for at least one temperature indicator to be attached to one of the brake linings of the disc brake, and for at least one further temperature indicator to be attached to a further component of the disc brake.

The temperature indicators may be of a wide variety of designs. In the simplest embodiment, it is provided that the temperature indicator includes a coating of paint. Depending on the size, the paint coating could be applied to a label or to a tag. However, a paint must be selected which is temperature-resistant up to a certain temperature, and changes its state thereafter, that is to say changes from a solid state into a liquid state. It is alternatively also possible for the temperature indicator to include a coating of an adhesive. The adhesive would likewise have to maintain its solid state up to a certain temperature and become liquid after exceeding that temperature. As an alternative to the latter solution, it is also possible for the temperature indicator to be a label or tag which is provided with an adhesive coating. Were the permitted temperature exceeded, the label or tag would then become detached, thus providing unequivocal proof of a thermal overload.

As an alternative to the previously described options, it is however also contemplated for the temperature indicator to be embodied as a mechanical display unit. This could be designed such that a component of the display unit does not change its position up to a certain temperature, and such that the display is not reset after the permitted operating temperature is exceeded. This could, for example, be provided by virtue of a resetting element being destroyed or damaged, or by virtue of a blocking element being activated.

The attachment of at least one temperature indicator is advantageous not only for the vehicle manufacturer and for the brake manufacturer, but also for the user, since it can be determined during an examination of the brake system as to whether a thermal overload has taken place. The cause for the thermal overload can then be sought.

Other objects, advantages and novel features of the present invention will become apparent from the following detailed description of the invention when considered in conjunction with the accompanying drawings.

### BRIEF DESCRIPTION OF THE DRAWING

FIG. 1 shows a front view of a brake lining for a disc brake according to the invention, including the retaining bracket.

### DETAILED DESCRIPTION OF THE DRAWING

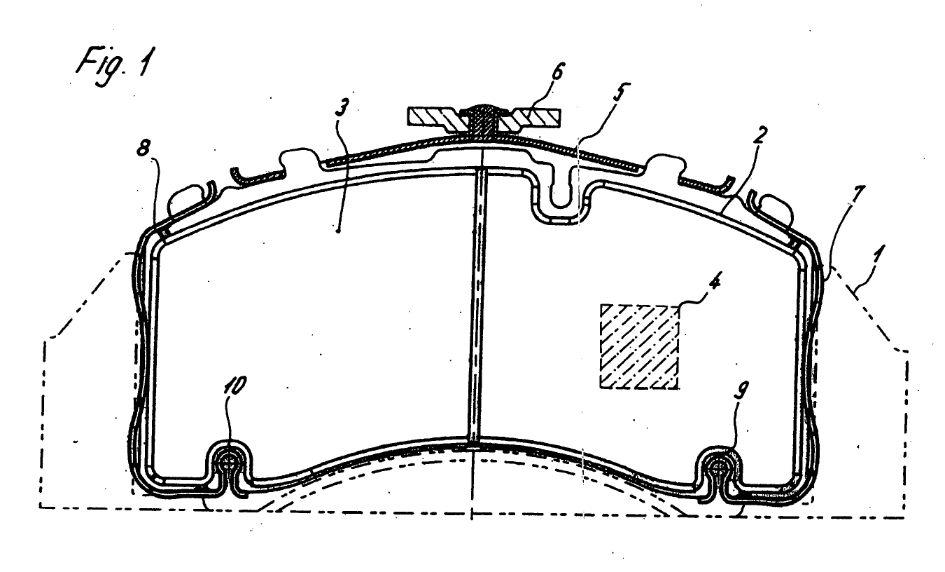

The brake lining arrangement illustrated in FIG. 1, is inserted in a brake lining slot 1 which is illustrated by way of a phantom line. The arrangement includes a lining support or carrier 2, which supports a layer 3 of brake lining material. In the illustrated exemplary embodiment, a temperature indicator 4 is arranged on a side of the lining carrier 2 which faces away from the layer 3. The temperature indicator 4 can, in the simplest form, be a coating of paint or of an adhesive which maintains its state up to a certain operating temperature of the disc brake. Alternatively, the temperature indicator 4 could also be an affixed label or an affixed tag whose adhesive layer is likewise temperature-resistant up to a predefined operating temperature of the disc brake. It would also be possible for the temperature indicator 4 to be embodied as a mechanical display unit. In the normal operating state, a needle displaying the temperature would always be able to return to the initial position. If a certain operating temperature were exceeded, however, it would be possible for the position of the needle to be blocked, for example by virtue of a return element being destroyed.

The attachment of the temperature indicator 4 to the side situated opposite the lining 3 is advantageous in that such a side is visible. The brake disc (not illustrated) of the disc brake, the lining support 2 and the brake material layer 3 are the thermally highest loaded components of the disc brake. In contrast to the illustrated embodiment, however, the temperature indicator 4 could also be attached to other components of the disc brake. In addition, it is expedient for greater certainty to attach a plurality of temperature indicators 4 to components of the disc brakes.

The lining carrier 2 and, therefore, the entire brake lining is suspended in a known way on a lining retaining spring 5. The lining retaining spring 5 is embodied as a leaf spring and is arranged on a retaining bracket 6. The lining retaining spring 5 serves to fix the brake lining in the brake lining slot 1, with radial tolerances also being compensated for. In the illustrated exemplary embodiment, two lining surround springs 7, 8, which exert pressure forces on the lining carrier 2 are inserted in the brake lining slot 1. The lining surround springs 7, 8 are embodied as shaped springs and act on the lateral regions, which are situated opposite one another, of the lining support 2, and on that side which is situated opposite the lining retaining spring 5. The lining surround springs 7, 8 may also be formed in one piece with the spring 5. As FIG. 1 shows, they are in contact with the lining support 2 only over a predefined or certain central region. Those end regions of the lining surround springs 7, 8 which are assigned to the lining retaining spring 5 are angled outward and engage behind angled lugs of the lining support 2. The end regions are connected in a positively-locking manner to the lining support 2 in this way. The other end regions of the lining surround springs 7, 8 are angled and formed in the shape of a lug in the end regions, likewise resulting in a positively-locking connection to the lining support 2. The angled end regions exert pressure forces on that side of the brake lining which is situated opposite the lining retaining spring 5. The lugs engage in recesses 9, 10 of the brake lining.

The invention is not restricted to the illustrated exemplary embodiment. It will be understood that it need only be possible to ascertain, by way of at least one temperature indicator 4, that the disc brake has been thermally overloaded. It is particularly advantageous for the temperature indicator 4 to be attached to the lining support 2 so as to be visible.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A disc brake for a vehicle, comprising:
a caliper which, in use, straddles a brake disc;
an application device arranged in the caliper;
brake linings configured to be selectively applied against the brake disc, one brake lining being arranged on each side of the brake disc when in use; and
at least one temperature indicator provided for the disc brake, the at least one temperature indicator operating to at least one of change state after a permitted operating temperature is exceeded and remain in a certain position after the permitted operating temperature is exceeded.

2. The disc brake according to claim 1, wherein each of the brake linings includes a lining support and lining material, the at least one temperature indicator being arranged on the lining support of at least one of the brake linings.

3. The disc brake according to claim 1, wherein a first temperature indicator is arranged on a first of the brake linings and a second temperature indicator is arranged on a second of the brake linings.

4. The disc brake according to claim 1, wherein a first temperature indicator is arranged on at least one of the brake linings of the disc brake and a second temperature indicator is arranged on another component of the disc brake.

5. The disc brake according to claim 1, wherein the temperature indicator comprises a paint coating.

6. The disc brake according to claim 2, wherein the temperature indicator comprises a paint coating.

7. The disc brake according to claim 4, wherein the temperature indicator comprises a paint coating.

8. The disc brake according to claim 1, wherein the temperature indicator comprises an adhesive coating.

9. The disc brake according to claim 2, wherein the temperature indicator comprises an adhesive coating.

10. The disc brake according to claim 4, wherein the temperature indicator comprises an adhesive coating.

11. The disc brake according to claim 1, wherein the temperature indicator comprises a label provided with an adhesive layer.

12. The disc brake according to claim 2, wherein the temperature indicator comprises a label provided with an adhesive layer.

13. The disc brake according to claim 4, wherein the temperature indicator comprises a label provided with an adhesive layer.

14. The disc brake according to claim 1, wherein the temperature indicator comprises a mechanical display unit.

15. The disc brake according to claim 2, wherein the temperature indicator comprises a mechanical display unit.

16. The disc brake according to claim 4, wherein the temperature indicator comprises a mechanical display unit.

17. A component of a disc brake for a vehicle, comprising:
a brake lining; and
a temperature indicator operatively configured with the brake lining, the temperature indicator operating to at least one of change state after a permitted operating temperature of the disc brake is exceeded and remain in a certain position after the permitted operating temperature is exceeded.

18. The component according to claim 17, wherein the brake lining includes a lining support, the temperature indicator being arranged on the lining support of the brake lining.

19. The component according to claim 18, wherein the temperature indicator comprises a paint coating.

20. The component according to claim 18, wherein the temperature indicator comprises an adhesive coating.

21. The component according to claim 17, wherein the temperature indicator is a mechanical display unit.
